(19) United States
(12) Patent Application Publication
(10) Pub. No.: US 2022/0106818 A1
(43) Pub. Date: Apr. 7, 2022

(54) VEHICLE DOOR HANDLE

(71) Applicant: Huf Hülsbeck & Fürst GmbH & Co. KG, Velbert (DE)

(72) Inventors: Mensur Velicanin, Velbert (DE); Michael Theidel, Mülheim (DE)

(73) Assignee: Huf Hülsbeck & Fürst GmbH & Co. KG, Velbert (DE)

(21) Appl. No.: 17/420,620

(22) PCT Filed: Oct. 15, 2019
(86) PCT No.: PCT/EP2019/077986

§ 371 Date: Jul. 2, 2021

(30) Foreign Application Priority Data
Jan. 8, 2019 (DE) 10 2019 100 319.9

(51) Int. Cl. E05B 85/10; B60J 5/04; E05B 81/76; E05B 77/02; E05B 81/78

(52) U.S. Cl. CPC E05B 85/107; B60J 5/0468; E05B 81/78; E05B 77/02; E05B 81/77

(57) ABSTRACT

A vehicle door handle having a grip for sensor-controlled triggering of a vehicle function, the grip being coupled to a handle housing which can be mounted on a vehicle. A coupling device and a motor are provided. The grip can be moved between a rest position and an extended actuation position by being driven by the motor via the coupling device. The grip has sensor components which sense an actuation force or communication device which sense a mobile communications device brought closer to the grip. The sensor components or the communication device are coupled to an interface via which actuation signals can be output. In both the actuation position and the rest position, the grip is coupled to the handle housing in a positionally fixed and travel-free manner over its entire extension and locked against deflection relative to the handle housing.

The invention relates to a vehicle door handle for motor vehicles. In particular, the invention relates to a vehicle door handle comprising a grip for sensor-controlled triggering of a vehicle function.

Motor vehicles, particularly cars, have different types of exterior vehicle door handles for the opening, closing and general handling of vehicle doors and tailgates. In conventional vehicle door handles, in the region of the skin of a vehicle, a grip region is usually arranged over a recessed region in the skin in order to provide an access region for the user's hand to grasp behind the grip. The grip that can be grasped by a user is coupled to a handle housing that can be fixed and mounted on the vehicle. The handle housing can be designed in the form of a carrier which is mounted on the inside of a door panel in order to provide a fixed support for the grip.

There are mechanically actuated vehicle door handles which, when actuated, transfer a change in position to a lock actuation via a mechanical chain. There are also electronic vehicle door handles (eLatch) comprising sensors to convert actuations by a user into electrical signals and to unlock the door by electronically forwarding actuation signals.

The common design of vehicle door handles uses grips that protrude from the skin of the vehicle at all times. However, there are also vehicle door handles that can be arranged in different functional positions on the vehicle door. In a resting state, these vehicle door handles can be placed so as to be retracted with respect to the skin of the vehicle such that they are flush with the surface of the door and are only extended with respect to the skin or the door panel when necessary to allow the user access. This both meets aesthetic demands and makes possible technical effects, in particular aerodynamic improvements and reductions in wind noise, since these vehicle door handles are retracted into the vehicle skin when not in use and are aerodynamically flush therewith.

Such extendable or retractable vehicle door handles have coupling means and a motor, the motor being arranged on the handle housing behind the door skin or in another position on the vehicle. The coupling means act between the grip and the motor in such a way that the grip can be moved between a rest position and an extended actuation position relative to the handle housing by being driven by the motor. In the rest position, the vehicle door handle is retracted into the vehicle skin and a top surface of the grip, which is oriented outwards, is aerodynamically flush with a top surface of the adjoining body portions.

A vehicle door handle of this kind is known from WO 2014/049026 A1, for example. The grip of such vehicle door handles can be equipped with sensor components that sense actuation forces acting on the grip in the extended operating position and provide derived actuation signals, with a wired interface assigned to the handle housing being provided for this purpose via which the actuation signals can be output to a control system in the vehicle. A wired interface of this kind allows a connection to the cable harness and control system of the vehicle. In addition, communication means can be provided in the grip, which communication means can sense a mobile communication device that is approaching the grip and can provide actuation signals derived from a communication established between the communication means and the communication device. For example, vehicle door handles which provide a wireless near-field interface e.g. an NFC interface) are known. If a user approaches with a mobile communication device that follows this communication standard, data which e.g. confirm the legitimacy of an access request such that the mobile communication device can be used as a vehicle key can be exchanged via the communication means in the grip.

Due to the numerous degrees of freedom of such systems, the designs of retractable vehicle door handles are complex and costly.

The invention is therefore based on the problem of providing a more robust and less expensive variant for retractable vehicle door handles.

The problem is solved by a vehicle door handle with the features of claim 1.

The vehicle door handle according to the invention is characterized in that, in both the actuation position and the rest position, the grip is coupled over the entire extension thereof to the housing in a positionally fixed and travel-free manner and is locked against deflection with respect to the handle housing.

In contrast to vehicle door handles which allow or require the user to change the position of the grip in the rest position or the actuation position in order to detect actuations, according to the invention, while the grip can be moved between the two positions, there are no changes in the position of the grip relative to the handle housing in the positions themselves. This means that there is no pivoting, tilting or translational movement of the grip of the vehicle door handle for actuating the vehicle door handle according to the invention. Instead, only electronic components which are provided in the grip in order to sense actuation forces on the handle or to use data communications for actuation recognition are used.

In this context, locking the grip against deflections should be understood to mean that no mechanical travel paths are provided in order to allow the grip to be actuated in the rest position or the actuation position. The grip is fixed in both the rest position and the actuation position in such a way that the actuation forces do not result in an actuation movement with respect to the handle housing. The locking is therefore to be designed in such a way that it ensures that the grip is positionally fixed only in the case of the usual access forces of a user.

The grip can have any desired design, and can in particular be designed as a bail-like grip or in the form of an extending or folding cantilever rocker arm. However, the outer top surface design of the grip is always aerodynamically flush with the surrounding body skin, provided that the grip is in the rest position.

The sensor components to be arranged in the grip for sensing acting actuation forces can have all types of sensors that are known for vehicle door handles, in particular capacitive sensors, inductive sensors, or mechanical switching means having microswitches and rocker switches or pistol grips. Piezo elements, which sense force effects on the grip, are also conceivable.

In a preferred embodiment, the grip of the vehicle door handle has a central portion along the longitudinal extension thereof that can be grasped from behind, and the grip also has connection attachments on both sides thereof, i.e. like a bail, the grip being couple to the handle housing on both sides of the central portion that can be grasped from behind, i.e. with both bracket ends, via coupling means and can be locked both in the actuation position and in the rest position.

Such bail-like grips ensure stable mounting of the grip on the vehicle and are particularly safe to use, since it is not possible for bag straps or items of clothing to get caught on the free end of the grip, for example.

The vehicle door handle preferably has activatable blocking means which lock the grip in the rest position and/or the actuation position and hold it in a positionally fixed manner. In addition to the motorized drive, mechanical locking elements secure the position of the grip in the rest position and/or the actuation position in this embodiment. These can, for example, be locking pins or releasable latching means that enter the movement path between the rest position and the actuation position of the grip as soon as they are activated. In order to move the grip from one of the positions to the other, the locking effect can be canceled by activating the blocking means, the position change is carried out, and, if necessary, the locking means are activated again in the other position in order to secure the position of the grip again. The same locking means can be used for each of the two positions or different locking means can be provided for the rest position and the actuation position.

In a preferred embodiment, the coupling means of the vehicle door handle and the motor are designed in such a way that the grip is locked in the rest position and/or the actuation position by frictional forces and the braking force of the motor in a positionally fixed manner.

With a suitable design of the coupling means and the motorized drive, these components can apply sufficient locking forces for the grip when the drive energy of the motor is removed, i.e. without energization, so that the braking force of the motor in combination with the frictional forces of the coupling means ensures sufficient locking. The motor can also act as a brake with a targeted energization by keeping the magnetic fields in the motor static.

In a further development of the invention, the grip is fixedly connected to a carrier plate, the coupling means engaging with the carrier plate so that the carrier plate and the grip can be moved together between the rest position and the actuation position.

The carrier plate can in particular be designed to close off the opening in the skin of the vehicle, which opening is covered by the grip itself in the rest position, when the grip is moved into the actuation position. In addition, such a carrier plate offers additional stabilization of the entire structure.

In a further preferred embodiment of the invention, the vehicle door handle has sensor components in the form of inductive sensors and/or capacitive sensors and/or mechanical switches.

Capacitive sensors are proven sensors in the region of vehicle door handles. They allow contact-free sensing as soon as a user approaches and can therefore detect operating processes at an early stage. Inductive sensors allow the sensing of very small material deformations in the region of the grip and detect changes in the position of a sensor in relation to adjacent metal parts. Mechanical switches can be used in combination with such sensors or on their own. Mechanical switching concepts for handling are, for example, microswitches that are provided with protective covers made of elastic material on the grip or pistol grips with microswitches or rocker switches in the region of the grip.

In a preferred embodiment of the vehicle door handle, the communication means in the grip are designed for a near-field communication standard, in particular the NFC communication standard. Since grips on vehicles are located at exposed locations, wireless contact with communication apparatuses in such a grip is particularly intuitive for a user. Users are used to accessing the grip and accept grips having near-field communication apparatuses arranged therein as trusted access points.

In a particularly preferred development of the invention, emergency unlocking means are also provided on the vehicle door handle, which emergency unlocking means, when force is exerted thereon, move the grip from the rest position into the actuation position independently of the motor.

In situations where, due to malfunctions in the on-board electrical system, the grip cannot be properly extended from the rest position to the actuation position, the actuatable emergency unlocking means allow the grip to be moved from the rest position to the actuation position. For this purpose, for example, a covered access region can be arranged next to the grip which, after removal of a cover, allows the grip to be reached under from the side. In addition, a Bowden cable can be provided which is coupled to the grip in order to extend the grip when the Bowden cable is pulled. The actuation point of the emergency release does not have to be arranged adjacently to the vehicle door handle; it can also be arranged at another point on the vehicle, for example in the rear region or under the vehicle.

The invention will now be explained in more detail with reference to the accompanying drawings.

FIG. 1 schematically shows the placement of vehicle door handles according to the invention on a vehicle;

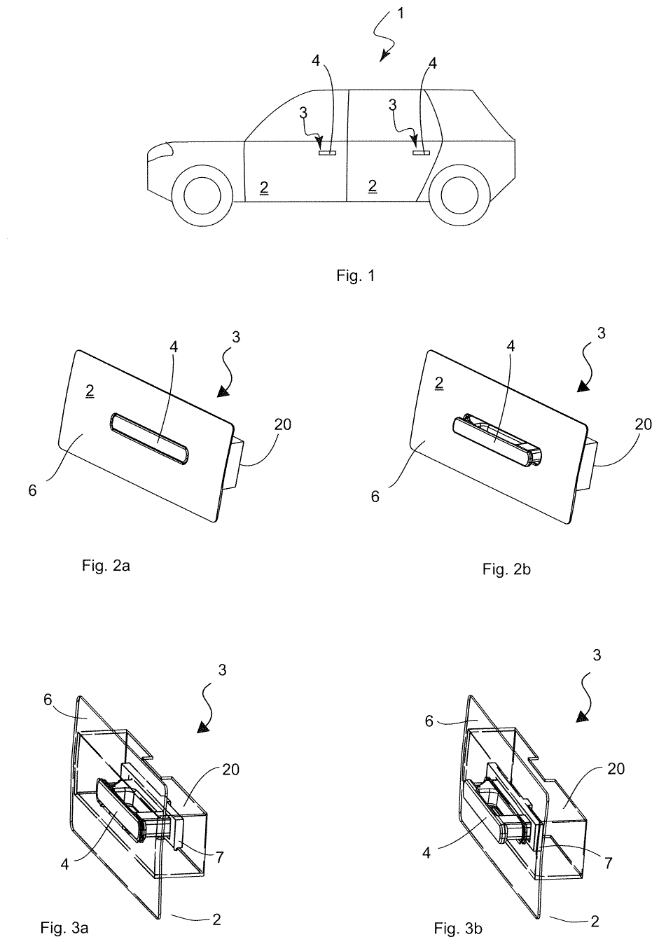

FIG. 2a schematically shows a vehicle door handle according to the invention with a grip in the rest position;

FIG. 2b is a schematic illustration of the vehicle door handle from FIG. 2a with the grip in the actuation position;

FIG. 3a is a semi-transparent view of the vehicle door handle from FIG. 2a;

FIG. 3b is a semi-transparent view of the vehicle door handle from FIG. 3b;

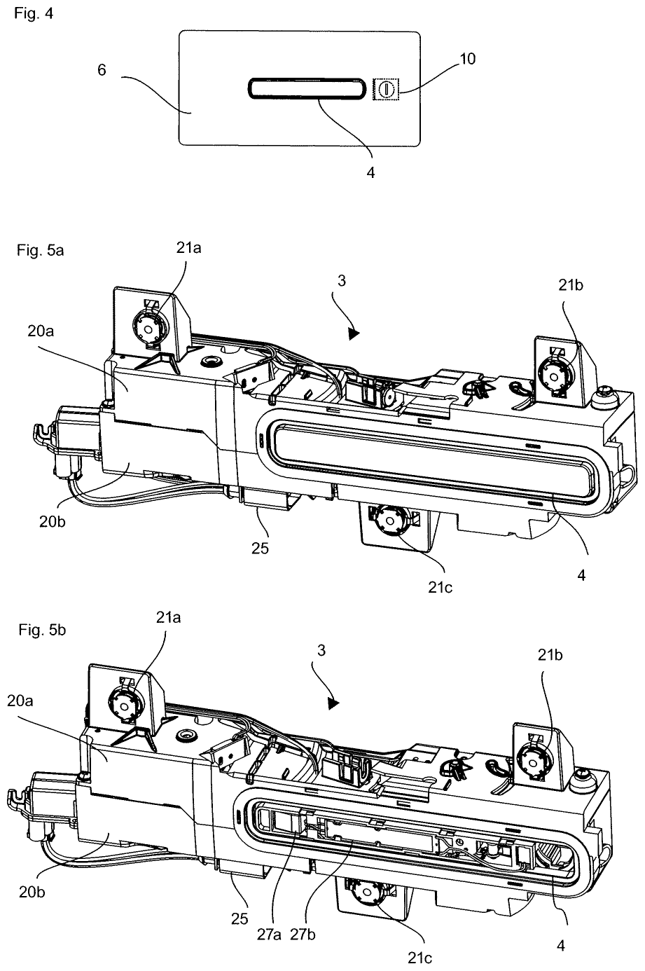

FIG. 4 shows the arrangement of a vehicle door handle according to the invention next to the lock cylinder of a motor vehicle;

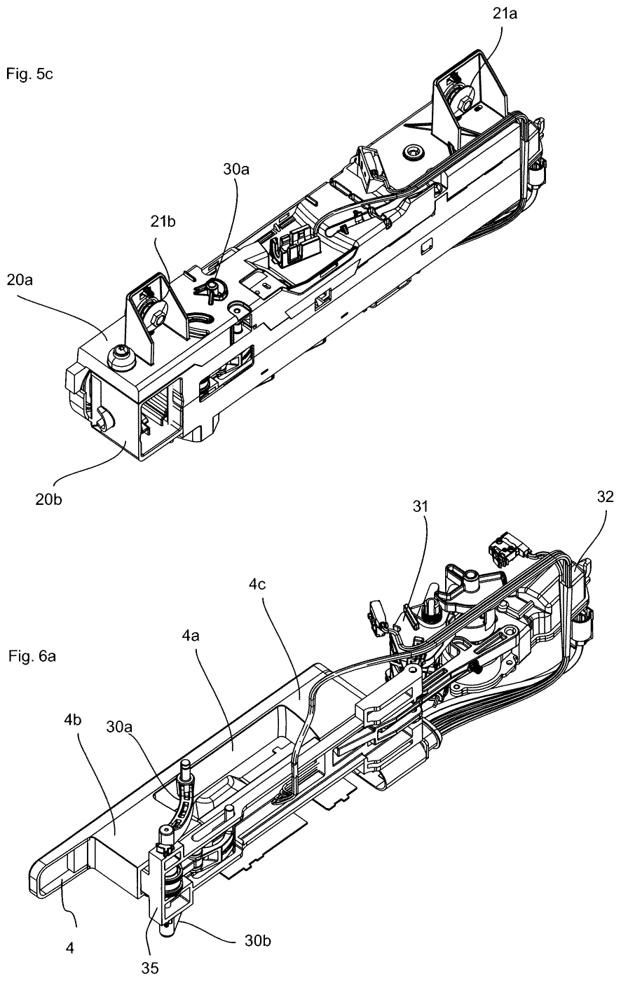

FIG. 5a shows an embodiment of the invention in a perspective frontal view;

FIG. 5b shows the arrangement from FIG. 5a, with the outwardly oriented cover side of the grip being removed;

FIG. 5c is a perspective rear view of the arrangement from FIGS. 5a and 5b;

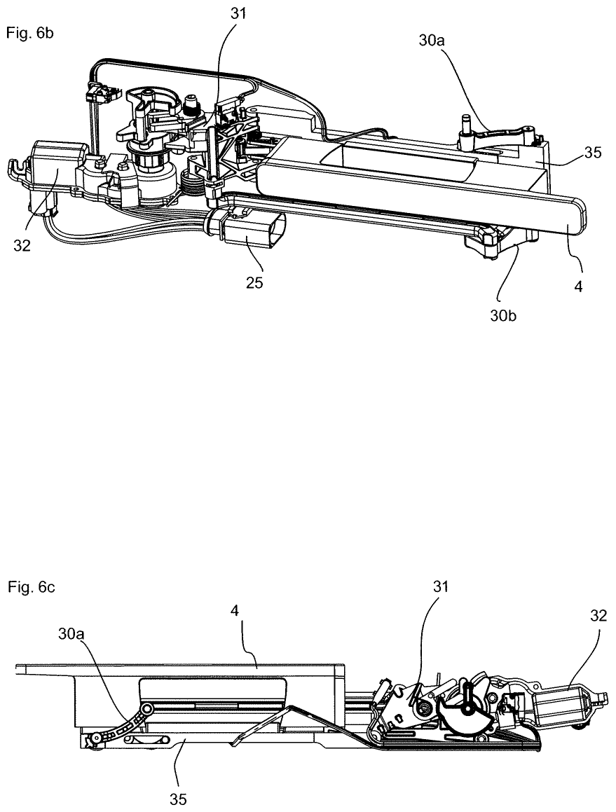

FIG. 6a shows essential components of the embodiments with the housing removed;

FIG. 6b is a plan view of the arrangement from FIG. 6a;

FIG. 6c is a plan view of the arrangement from FIGS. 6a and 6b;

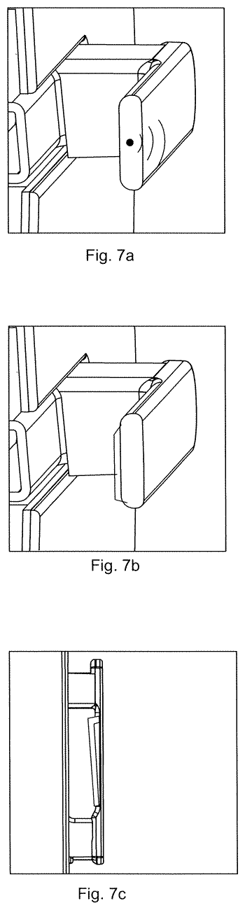

FIG. 7a is a schematic diagram of the arrangement of communication means in the grip;

FIG. 7b is a schematic diagram of the arrangement of a first mechanical switch in a grip;

FIG. 7c is a schematic diagram of the design of the grip of a vehicle door handle according to the invention with pistol-grip actuation.

FIG. 1 shows a vehicle 1 comprising doors 2 on which vehicle door handles 3 are arranged. These vehicle door handles 3 are each equipped with grips 4 which are guided through corresponding recesses in the skins of the doors 2.

FIG. 2a shows a portion of the doors 2 in which the vehicle door handle 3 is arranged. In FIG. 2a, the door panel 6 forms the skin of the door 2 and the grip 4 is in the rest position. In this rest position, the surface of the grip 4 is designed to be aerodynamically flush with the surrounding door panel 6. On the back of the door panel 6, i.e. on the inside of the door, a housing 8 is arranged which is fixed to the door panel 6 and accommodates coupling means and a motor for driving the grip 4.

The arrangement from FIG. 2a is shown in FIG. 2b with the grip 4 in the actuation position, i.e. in an extended position with respect to the door panel 6. The grip 4 is designed as a bail, i.e. with a central portion that can be grasped from behind and bail end pieces arranged on both sides thereof, so that a user can grasp behind the grip. With such a connection on both sides of the central engageable portion of the grip, the risk of anything being caught behind free ends of the grip is reduced compared to cantilever engageable portions.

FIG. 3a is a semi-transparent view of the arrangement from FIG. 2a. The grip 4 is located in the rest position here, i.e. in a position in which the outwardly facing cover side of the grip is in alignment with the surrounding door panel 6. As can be seen in this view, the grip 4 is arranged on a carrier plate 7 which serves as a mounting plate for the grip 4 and also follows the movement of the grip 4 from the rest position into the actuation position. Coupling means (not shown here) are arranged on the carrier plate 7 which couple the carrier plate to a motorized drive (not shown here) in order to transfer the carrier plate 7 from the rest position (in FIG. 3a) to the actuation position (in FIG. 3b).

As shown in FIG. 4, in addition to the grip 4, further functional components can also be arranged in the vicinity of the vehicle door handle, e.g. a lock cylinder 10. This can be accommodated in the same housing that accommodates the coupling means and the motor for the grip 4, but the lock cylinder 10 is spaced apart from the movable grip itself so that no complex mechanical functional chains pass through the grip 4.

FIG. 5a is a first view of a more specific embodiment of a vehicle door handle according to the invention. Here, the housing 20a, 20b has an upper housing part 20a and a lower housing part 20b. Mounting points 21a, 21b, and 21c are provided to fix the housing 20a, 20b to an inside of the vehicle door. A grip 4 is shown in its rest position, retracted into the housing 20a, 20b. A wired interface 25 that can be coupled to the vehicle control system forwards control signals to the vehicle door handle and forwards detected sensor signals and communication signals to the vehicle system via the interface.

The grip, the cover of which is removed in FIG. 5b, contains sensor components 27a which are arranged on a printed circuit board located in the grip. In addition, communication means 27b for near-field communication are arranged on the printed circuit board. The sensor components 27a and the communication means 27b are accommodated in the grip 4 in such a way that they are moved together with the grip, i.e. moved from the rest position to the actuation position.

FIG. 5c shows the embodiment of the vehicle door handle in an oblique view from behind. The two housing parts 20a and 20b of the housing are also shown here, together with the mounting points 21a and 21b.

In FIG. 6a, essential components of the vehicle door handle are shown from the same perspective as in FIG. 5c, but the housing parts 20a and 20b are hidden to allow a view of the inner components of the vehicle door handle. The grip 4 is fixedly connected to a carrier plate 35. The carrier plate 35 is coupled to a motorized drive 32 via coupling means 30a, 30b, 31. By being driven by the motor 32, the coupling means 30a, 30b, 31 can be moved in such a way that the grip 4, together with the carrier plate 35, is brought from the rest position into the actuation position. For this reason, the coupling means 30a, 30b, 31, as shown in FIG. 5c, are coupled to the recess in the housing for pivoting the grip, so that the grip 4 is moved relative to the housing 20a, 20b. For this purpose, the coupling means 30a, 30b, 31 have lever arms 30a and 30b on one side of the grip 4 which are coupled to the housing 20a, 20b. On the other longitudinal end of the grip, the carrier plate 35 is coupled to a drivable lever arm 31. The introduction of force by the motor 32 into the lever arm 31 and pivoting of the lever arm 31 causes the grip 4 to be extended from its rest position into the actuation position, the lever arms 30a, 30b being entrained by mechanical coupling and specifying the movement path of the grip 4. By being articulated to the coupling means, the grip 4 moves out of its rest position into the extended position, the lever arms 30a, 30b being pivoted in their respective bearings in the housing while the lever arm 31 converts the introduction of force from the motor 22 into a pivoting movement.

FIG. 6b shows the arrangement from FIG. 6a in a frontal view. In this view, the coupling means, which contain the lever arms 30a, 30b, and 31, can be seen more clearly.

In FIG. 6c shows the same arrangement as in FIGS. 6a and 6b, but in a plan view.

It is clear from each of FIGS. 6a, 6b and 6c that the coupling means 30a, 30b, and 31 engage with the carrier plate 35, said plate being fixedly connected to the grip 4 or formed integrally therewith.

These views also show that the mechanical design outlay for the vehicle door handle according to the invention is significantly lower than for comparable retractable vehicle door handles since no travel paths need to be provided for actuation by a user. The grip 4 is not pivoted or deflected in a translatory manner relative to the housing in any way for actuation either in the rest position or in the actuation position of the grip 4. Only the movement from the rest position to the actuation position is ensured by the mechanical components, which allow an extremely simple structural design. In addition, all actuation signals are to be received by the electronic components in the grip 4 and output to a control system in the vehicle via the interface 25.

FIGS. 7a, 7b, and 7c show different designs of a grip with electronic components accommodated therein.

FIG. 7a shows a sectional view of a grip to aid the visualization the position of a near-field communication device in the grip. An NFC communication apparatus allows communication to be carried out between this apparatus and a mobile communication device, for example a user's smartphone. This device can thus transmit control signals to the vehicle, for example to trigger actions such as unlocking the vehicle or locking the vehicle.

FIG. 7b is a sectional view of a grip having an operating surface that faces the vehicle on the inside of the grip, which is designed as a mechanical rocker switch. A rocker of this kind transmits a manual actuation to a microswitch and generates corresponding switching signals without the grip being moved with respect to its actuation position; only the switch components are adjusted with respect to the grip.

FIG. 7c shows a further alternative design of a grip according to the invention, in which the central, actuatable portion of the grip is equipped with a pistol grip that is also coupled to a microswitch or another switch sensor. Here, too, the grip is stationary in its actuation position, and the switching components are drawn into the vehicle interior together with the grip, provided that the grip passes from the actuation position to the rest position.

1. A vehicle door handle, comprising:
a grip for sensor-controlled triggering of a vehicle function,
the grip being coupled to a handle housing that can be mounted on a vehicle;
a coupling means and a motor being provided, the motor being arranged on the handle housing or on the vehicle, and the coupling means coupling the grip and the motor in such a way that the grip can be moved between a rest position and an extended actuation position relative to the handle housing (20a, 20b) by being driven by the motor;
the vehicle door handle configured for mounting in a body recess of a vehicle such that a top surface of the grip is flush with a top surface of an adjoining body portion in the rest position;
the grip having sensor components which sense an actuation force acting on the grip and provide derived actuation signals,
and/or having communication means which sense a mobile communication device approaching the grip and provide actuation signals derived from a communication established between the communication means and the communication device;
and the sensor components and/or the communication means being coupled to a wired interface which is assigned to the handle housing and via which the actuation signals can be output to a control system in the vehicle;
wherein,
in both the actuation position and the rest position, the grip is coupled over the entire extension thereof to the handle housing in a positionally fixed and travel-free manner and is locked against deflection with respect to the handle housing.

2. The vehicle door handle according to claim 1, wherein the grip has a central portion along the longitudinal extension thereof that can be grasped from behind, and the grip also has a connection attachment on both sides thereof by means of which the coupling means are connected, such that the grip, on both sides of the central portion that can be grasped from behind, is coupled to the handle housing via the coupling means and can be locked in both the actuation position and the rest position.

3. The vehicle door handle according to claim 1, wherein activatable locking means are provided which lock the grip in the rest position and/or the actuation position and hold it in a positionally fixed manner.

4. The vehicle door handle according to claim 1, wherein the coupling means and the motor are designed in such a way that the grip is held in the rest position and/or the actuation position by frictional forces and the braking force of the motor in a positionally fixed manner.

5. The vehicle door handle according to claim 1, wherein the grip is fixedly connected to a carrier plate and the coupling means engaging with the carrier plate such that the carrier plate, together with the grip, can be moved between the rest position and the actuation position.

6. The vehicle door handle according to claim 1, wherein the sensor components have an inductive sensor and/or a capacitive sensor and/or a mechanical switch.

7. The vehicle door handle according to claim 1, wherein the communication means are designed for near-field communication, in particular communication according to the NFC standard.

8. The vehicle door handle according to claim 1, wherein the coupling means are coupled to actuatable emergency unlocking means which, when force is exerted on the emergency unlocking means, move the grip from the rest position into the actuation position independently of the motor.
